(19) United States
(12) Patent Application Publication
(10) Pub. No.: US 2005/0240316 A1
(43) Pub. Date: Oct. 27, 2005

(54) Method and apparatus for minimizing acoustic noise from a set of cooling fans

(76) Inventor: David W. Mayer, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/832,962

(22) Filed: Apr. 26, 2004

(51) Int. Cl. G05D 23/00

(52) U.S. Cl. 700/300

(57) ABSTRACT

The acoustic noise produced by a set of cooling fans in an electronic system is minimized by determining, for each of a set of operating points, a combination of fan speeds that minimizes the total acoustic noise. The technique may be applied to a variety of electronic systems, including workstations.

### FIELD OF THE INVENTION

The present invention relates generally to electronic systems and more specifically to techniques for cooling electronic systems.

### BACKGROUND OF THE INVENTION

Cooling an electronic system to maintain an acceptable operating temperature is important in many applications. Cooling is often accomplished by the use of multiple cooling fans. For example, a heat-sink fan may be used to cool a particular component, and a system fan may be used to cool a particular thermal zone within the electronic system. Often, there is a thermally limiting component such as a microprocessor within a given thermal zone. So long as this critical component is cooled properly, the other components will remain below their maximum acceptable temperatures. To cool the critical component, cooling fans are typically driven at a fixed speed that depends on the measured temperature of the critical component. As the temperature of the critical component rises, the speed of the fans is also increased to provide additional cooling power. A linear increase in speed of all cooling fans in the thermal zone may effectively cool the processor, but that particular combination of fan speeds may produce more acoustic noise than necessary to provide adequate cooling.

Acoustic noise from cooling fans is a common complaint among users of electronic systems such as workstations. The problem is especially bothersome where multiple workstations are used in close proximity, as is often the case in research and development organizations.

It is thus apparent that there is a need in the art for an improved method and apparatus for minimizing acoustic noise produced by a set of cooling fans in an electronic system.

### SUMMARY OF THE INVENTION

A method for minimizing the acoustic noise produced by a set of cooling fans in an electronic system is provided. An apparatus for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an illustration of an electronic system in accordance with an illustrative embodiment of the invention.

FIG. 2 is a functional block diagram of a cooling fan control system within the electronic system shown in FIG. 1 in accordance with an illustrative embodiment of the invention.

FIG. 3A is a flowchart of a method for minimizing the acoustic noise produced by a set of cooling fans in accordance with an illustrative embodiment of the invention.

FIG. 3B is a flowchart of a method for determining, for each of a set of predetermined operating points, a combination of cooling fan speeds that minimizes the total acoustic noise produced by a set of cooling fans in accordance with an illustrative embodiment of the invention.

### DETAILED DESCRIPTION OF THE INVENTION

Acoustic noise produced by a set of cooling fans in an electronic system may be minimized for a given desired cooling power (“operating point”) by operating each cooling fan at a speed such that the combined acoustic noise of the set of cooling fans is minimized. The particular speed combination that minimizes the total acoustic noise for a given operating point may be determined in advance and stored, for example, in a look up table. As the electronic system is operated, a temperature in the electronic system may be measured (e.g., that of a critical component), and a predetermined operating point may be selected in accordance with the measured temperature. The set of cooling fans may then be operated at the particular combination of fan speeds associated with the selected operating point. This achieves the desired cooling effect without unnecessary acoustic noise.

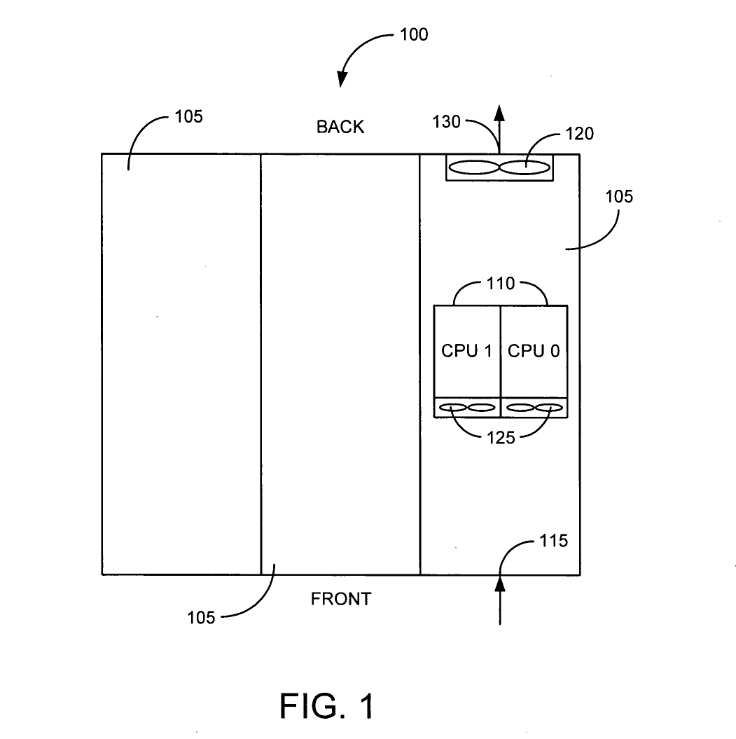

FIG. 1 is an illustration of an electronic system 100 in accordance with an illustrative embodiment of the invention. Electronic system 100 may comprise one or more thermal zones 105, which may be physically partitioned in some applications. The rightmost thermal zone 105 in FIG. 1 includes two microprocessors 110, which, for the sake of this detailed description, are assumed to be thermally limiting (critical) components. That is, it is assumed that when these critical components 110 have been acoustically optimized in accordance with the invention, no other component in thermal zone 105 requires additional heat sinking. Air is drawn into thermal zone 105 through intake vent 115 by system fan 120 and heat-sink fans 125. The heated air is expelled from electronic system 100 through exhaust vent 130.

Electronic system 100 may be any of a variety of types, including a workstation.

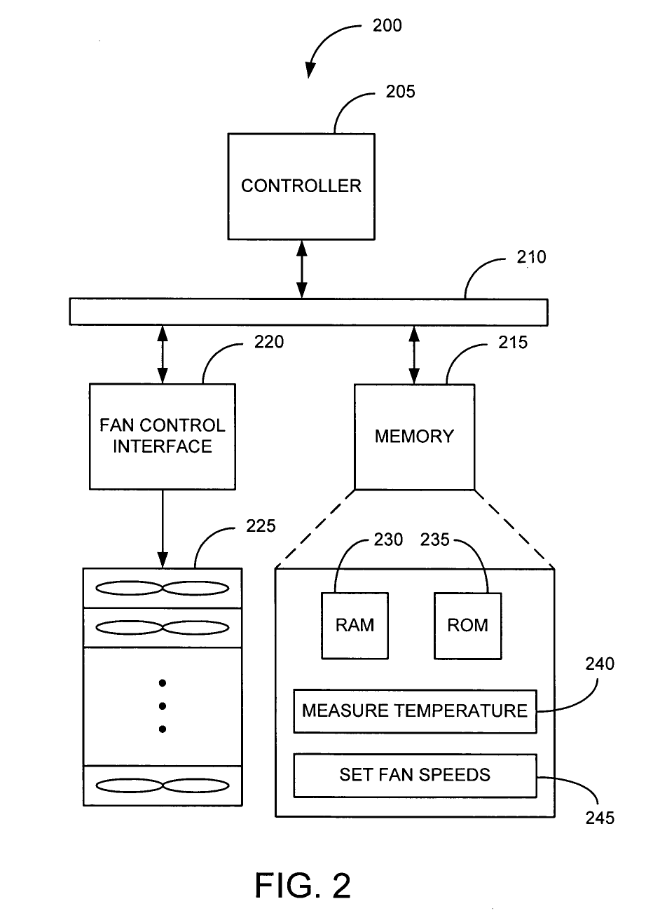

FIG. 2 is a functional block diagram of a cooling fan control system 200 within the electronic system shown in FIG. 1 in accordance with an illustrative embodiment of the invention. In FIG. 2, controller 205 communicates over data bus 210 with memory 215 and fan control interface 220. Fan control interface 220 interfaces a set of cooling fans 225 with controller 205 and a power supply (not shown in FIG. 2). Each cooling fan within set 225 may, in general, be a system fan 120 or a heat-sink fan 125, as shown in FIG. 1. Controller 205 may comprise, for example, a microprocessor or microcontroller. Memory 215 may further comprise random access memory (RAM) 230, read-only memory (ROM) 235, module measure temperature 240, and module set fan speeds 245. Module measure temperature 240 may poll a temperature measurement function of a critical component such as microprocessors 110 in conjunction with selecting a particular operating point for cooling fan control system 200. Module set fan speeds 245 may set the speed of each cooling fan in set 225 to a predetermined speed associated with the selected operating point such that the total acoustic noise produced by set 225 is minimized.

Cooling fan control system 200 may be implemented in a variety of ways well known to those skilled in the art. For example, the functions of controller 205, memory 215, and fan control interface 220 may be implemented in a single special-purpose integrated circuit (IC). In another illustrative embodiment, module measure temperature 240 and module set fan speeds 245 may be firmware that is executed by a processor such as microprocessors 110. In general, cooling fan control system 200 may be implemented as hardware, firmware, software, or any combination thereof.

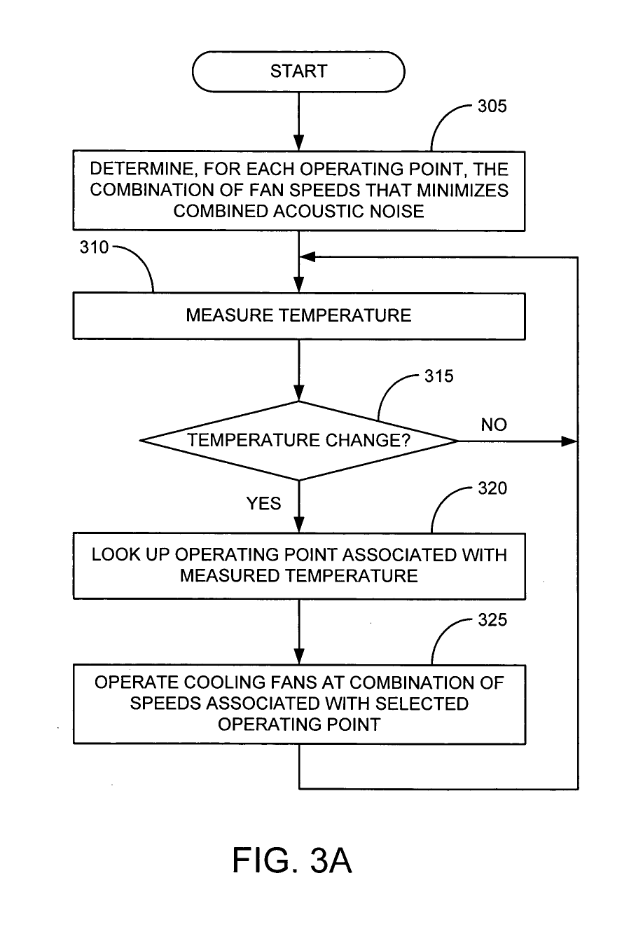

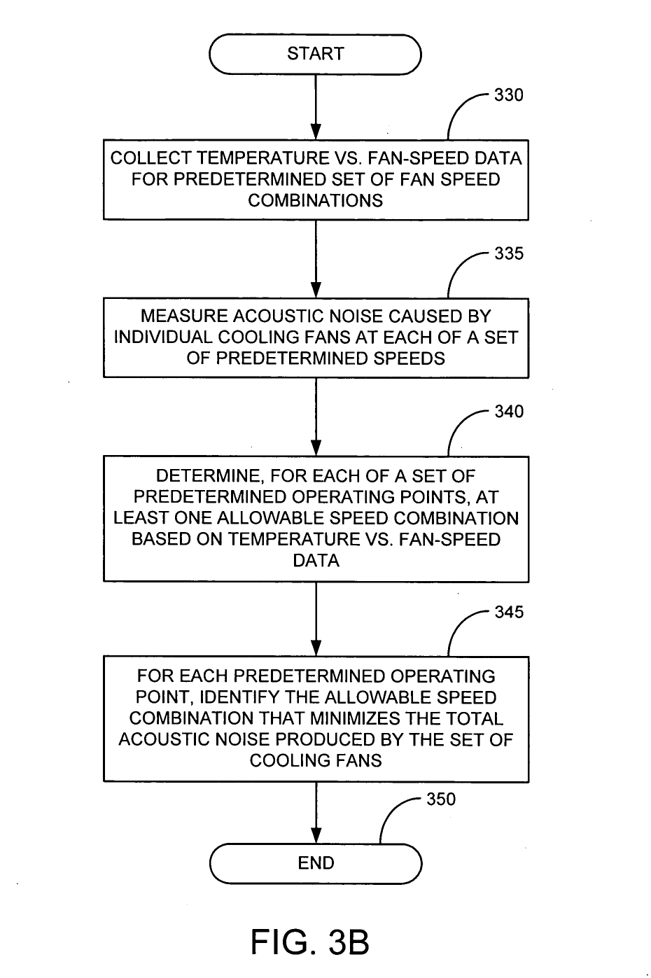

FIG. 3A is a flowchart of a method for minimizing the acoustic noise produced by set of cooling fans 225 in accordance with an illustrative embodiment of the invention. At 305, the combination of fan speeds that minimizes the combined acoustic noise produced by set 225 is determined for each of a set of predetermined operating points. This step may be performed once in advance and the results stored in, for example, a lookup table (see FIG. 3B). At 310, module measure temperature 240 may measure a temperature in electronic system 100. For example, the temperature measured may be that of a critical component 110. At 320, module set fan speeds 245 may select a predetermined operating point associated with the temperature measured at 310. This may be accomplished by, for example, consulting a lookup table. At 325, module set fan speeds 245 may set the respective speeds of the cooling fans in set 225 at the predetermined particular combination of fan speeds that, for the selected operating point, minimizes the total acoustic noise produced by set 225.

Fan control interface 220 may set the speed of individual cooling fans based on, for example, a constant drive voltage. Alternatively, the duty cycle of a pulse-width-modulated (PWM) signal with a fixed peak voltage may determine the speed at which individual cooling fans operate. Other methods of establishing the desired speed of a particular cooling fan may be employed, all of which are considered to be within the scope of the invention as claimed. The test at 315 ensures that, once a particular operating point has been established, a change in measured temperature will result in the operating point being updated accordingly at 320 and 325.

FIG. 3B is a flowchart of a method for determining, for each of a set of predetermined operating points, a combination of cooling fan speeds that minimizes the total acoustic noise produced by a set of cooling fans 225 in accordance with an illustrative embodiment of the invention. At 330, temperature vs. fan-speed data may be collected for each of a predetermined set of fan-speed combinations. For example, a particular range of allowable fan drive voltages for each individual cooling fan may be decided upon at the outset. In an embodiment employing a PWM drive signal, a range of allowable effective fan drive voltages based on the duty cycle of the PWM signal may be chosen. For the remainder of this description, the single term “fan voltage” will be used to refer, interchangeably, to a constant drive voltage or an effective drive voltage. For example, a particular embodiment may require that fan voltages lie within the range of 5 V to 12 V. At 330, data may be collected concerning the temperature of a critical component 110 at each possible combination of fan voltages, the speed of each cooling fan being varied in discrete steps. For the purpose of this description and by way of illustration only, a one-volt step size is assumed. In some applications, a 0.5-V step or some other step size may be preferable. Such data may be mathematically modeled, for example, based on an assumed ratio of cooling effectiveness between a heat-sink fan (HSF) 125 and a system fan (SF) 120. Table 1 shows an example of the kind of data that may be collected at 330.

TABLE 1

| | | 5 V SF | | 6 V SF | 7 V SF | 8 V SF | 9 V SF | 10 V SF | 11 V SF | 12 V SF |
|---|---|---|---|---|---|---|---|---|---|---|
| 5 | V HSF | 103 | C. | 99 C. | 95 C. | 91 C. | 87 C. | 83 C. | 78 C. | 74 C. |
| 6 | V HSF | 101 | C. | 97 C. | 93 C. | 89 C. | 85 C. | 80 C. | 76 C. | 72 C. |
| 7 | V HSF | 99 | C. | 95 C. | 91 C. | 87 C. | 83 C. | 78 C. | 74 C. | 70 C. |
| 8 | V HSF | 97 | C. | 93 C. | 89 C. | 85 C. | 80 C. | 76 C. | 72 C. | 68 C. |
| 9 | V HSF | 95 | C. | 91 C. | 87 C. | 83 C. | 78 C. | 74 C. | 70 C. | 66 C. |
| 10 | V HSF | 93 | C. | 89 C. | 85 C. | 80 C. | 76 C. | 72 C. | 68 C. | 64 C. |
| 11 | V HSF | 91 | C. | 87 C. | 83 C. | 78 C. | 74 C. | 70 C. | 66 C. | 62 C. |
| 12 | V HSF | 89 | C. | 85 C. | 80 C. | 76 C. | 72 C. | 68 C. | 64 C. | 60 C. |

At 335, the acoustic noise produced by each individual cooling fan at each of a set of predetermined fan voltages (speeds) may be measured. Table 2 shows an example of the kind of data that may be obtained at 335 for two cooling fans (one system fan 120 and one heat sink fan 125) in set 225.

TABLE 2

| | | | |
|---|---|---|---|
| HSF | dB | SF | dB |

| | | | | | |
|---|---|---|---|---|---|
| 5.0 | V | 35.7 dB | 5.0 | V | 40.0 dB |
| 6.0 | V | 37.7 dB | 6.0 | V | 42.9 dB |
| 7.0 | V | 39.8 dB | 7.0 | V | 45.7 dB |
| 8.0 | V | 41.8 dB | 8.0 | V | 48.6 dB |
| 9.0 | V | 43.8 dB | 9.0 | V | 51.4 dB |
| 10.0 | V | 45.8 dB | 10.0 | V | 54.3 dB |
| 11.0 | V | 47.9 dB | 11.0 | V | 57.1 dB |
| 12.0 | V | 49.9 dB | 12.0 | V | 60.0 dB |

The example shown in FIG. 2 may be generalized to sets 225 including more than two cooling fans.

At 340, allowable fan-voltage (speed) combinations (based on the allowable range of fan voltages selected at the outset) may be determined for each of a set of predetermined operating points. In this example, the allowable voltage range is 5 V to 12 V. At least one allowable voltage combination is identified for each predetermined operating point. For some predetermined operating points, multiple allowable fan voltage combinations may achieve the same cooling effect, although the acoustic characteristics of those allowable fan combinations may differ. Table 3 shows an example of step 340 for an arbitrary set of data for which a linear relationship between cooling power and fan speed has been assumed. In Table 3, allowable fan voltage combinations are indicated in bold, underlined type.

TABLE 3

| Operating | | | | | | | | | |
|---|---|---|---|---|---|---|---|---|---|
| Point | | 5 V SF | 6 V SF | 7 V SF | 8 V SF | 9 V SF | 10 V SF | 11 V SF | 12 V SF |
| 103.0 | C. | 5.0 V | 3.0 V | 1.0 V | −1.0 V | −3.0 V | −5.0 V | −7.0 V | −9.0 V |
| | | HSF | HSF | HSF | HSF | HSF | HSF | HSF | HSF |
| 98.2 | C. | 7.3 V | 5.3 V | 3.3 V | 1.3 V | −0.7 V | −2.7 V | −4.7 V | −6.7 V |
| | | HSF | HSF | HSF | HSF | HSF | HSF | HSF | HSF |
| 93.4 | C. | 9.7 V | 7.7 V | 5.7 V | 3.7 V | 1.7 V | −0.3 V | −2.3 V | −4.3 V |
| | | HSF | HSF | HSF | HSF | HSF | HSF | HSF | HSF |
| 88.7 | C. | 12.0 V | 10.0 V | 8.0 V | 6.0 V | 4.0 V | 2.0 V | 0.0 V | −2.0 V |
| | | HSF | HSF | HSF | HSF | HSF | HSF | HSF | HSF |
| 83.9 | C. | 14.3 V | 12.3 V | 10.3 V | 8.3 V | 6.3 V | 4.3 V | 2.3 V | 0.3 V |
| | | HSF | HSF | HSF | HSF | HSF | HSF | HSF | HSF |
| 79.1 | C. | 16.7 V | 14.7 V | 12.7 V | 10.7 V | 8.7 V | 6.7 V | 4.7 V | 2.7 V |
| | | HSF | HSF | HSF | HSF | HSF | HSF | HSF | HSF |
| 74.3 | C. | 19.0 V | 17.0 V | 15.0 V | 13.0 V | 11.0 V | 9.0 V | 7.0 V | 5.0 V |
| | | HSF | HSF | HSF | HSF | HSF | HSF | HSF | HSF |
| 69.6 | C. | 21.3 V | 19.3 V | 17.3 V | 15.3 V | 13.3 V | 11.3 V | 9.3 V | 7.3 V |
| | | HSF | HSF | HSF | HSF | HSF | HSF | HSF | HSF |
| 64.8 | C. | 23.7 V | 21.7 V | 19.7 V | 17.7 V | 15.7 V | 13.7 V | 11.7 V | 9.7 V |
| | | HSF | HSF | HSF | HSF | HSF | HSF | HSF | HSF |
| 60.0 | C. | 26.0 V | 24.0 V | 22.0 V | 20.0 V | 18.0 V | 16.0 V | 14.0 V | 12.0 V |
| | | HSF | HSF | HSF | HSF | HSF | HSF | HSF | HSF |

For each predetermined operating point, the allowable fan voltage combination that minimizes the total acoustic noise produced by set 225 may be identified at 345. For example, the fan voltage combination 5.3 V HSF (heat-sink) fan and 6 V SF (system fan) in Table 3 may yield a total acoustic noise level of 43.7 dB. The combination 7.3 V HSF and 5 V SF may achieve the same operating point, 98.2 C, but the associated total acoustic noise level may be 43.2 dB. In this case, the combination 7.3 V HSF and 5 V SF would be preferred for the operating point 98.2 C because it has a lower associated acoustic noise level. An example of completed step 345 is shown in Table 4. In Table 4, the allowable fan-voltage combination from Table 3 that minimizes the total acoustic noise for each predetermined operating point is indicated in bold, underlined type.

TABLE 4

| Operating | | | | | | | | | |
|---|---|---|---|---|---|---|---|---|---|
| Point | | 5 V SF | 6 V SF | 7 V SF | 8 V SF | 9 V SF | 10 V SF | 11 V SF | 12 V SF |
| 103.0 | C. | 41.4 | | | | | | | |
| | | dB | | | | | | | |
| 98.2 | C. | 43.2 | 43.7 | | | | | | |
| | | dB | dB | | | | | | |
| 93.4 | C. | 46.3 | 45.1 | 46.3 | | | | | |
| | | dB | dB | dB | | | | | |
| 88.7 | C. | 50.3 | 47.6 | 47.2 | 48.9 | | | | |
| | | dB | dB | dB | dB | | | | |
| 83.9 | C. | | | 49.1 | 49.5 | 51.6 | | | |
| | | | | dB | dB | dB | | | |
| 79.1 | C. | | | | 51.0 | 52.0 | 54.4 dB | | |
| | | | | | dB | dB | | | |
| 74.3 | C. | | | | | 53.0 | 54.7 dB | 57.2 dB | 60.0 dB |
| | | | | | | dB | | | |
| 69.6 | C. | | | | | | 55.3 dB | 57.4 dB | 60.0 dB |
| 64.8 | C. | | | | | | | 57.8 dB | 60.1 dB |
| 60.0 | C. | | | | | | | | 60.4 dB |

Once an allowable fan-voltage combination that minimizes the total acoustic noise has been selected for each operating point at 345 (see Table 4), the selected set of allowable fan-speed combinations and their corresponding operating points may be stored in a lookup table. For a given temperature measured by module measure temperature 240 at 310 in FIG. 3A, module set fan speeds 245 may select a suitable operating point from the lookup table. Module set fan speeds 245 may also select from the lookup table the particular combination of fan speeds that minimizes the total acoustic noise for the selected operating point. An example of a lookup table mapping predetermined operating points to fan voltages is shown in Table 5.

TABLE 5

| | | |
|---|---|---|
| Operating | | |
| Point | HSF | SF |

| | | | | | |
|---|---|---|---|---|---|
| 103.0 | C. | 5.0 | V | 5.0 | V |
| 98.2 | C. | 7.3 | V | 5.0 | V |
| 93.4 | C. | 7.7 | V | 6.0 | V |
| 88.7 | C. | 8.0 | V | 7.0 | V |
| 83.9 | C. | 10.3 | V | 7.0 | V |
| 79.1 | C. | 10.7 | V | 8.0 | V |
| 74.3 | C. | 11.0 | V | 9.0 | V |
| 69.6 | C. | 11.3 | V | 10.0 | V |
| 64.8 | C. | 11.7 | V | 11.0 | V |
| 60.0 | C. | 12.0 | V | 12.0 | V |

The particular method shown in FIG. 3B and Tables 1-5 for determining, for each of a set of predetermined operating points, a combination of cooling fan speeds that minimizes the total acoustic noise produced by set 225 is only one illustrative example. Many other variations of this procedure are possible, all of which are considered to be within the scope of the invention as claimed.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A toilet seat device for attaching to lavatory bowls of toilets, said toilet seat device comprising:
a seat for being disposed on the lavatory bowl, and said seat including a recess formed therein, and including at least one protrusion extended in said recess of said seat and having a screw hole formed therein, and
means for fastening said seat to the lavatory bowl, said fastening means including at least one bar for engaging onto the lavatory bowl, and at least one fastener engaged with said at least one bar, and for threading with said screw hole of said at least one protrusion, to secure said at least one bar and said seat to the lavatory bowl.

2. (canceled)

3. The toilet seat device as claimed in claim 1, wherein said at least one fastener includes a knob provided thereon and extended out of said at least one bar.

4-5. (canceled)

6. The toilet seat device as claimed in claim 1, wherein said seat includes at least one slot formed therein, and defined by said at least one protrusion, and said at least one bar includes at least one peg extended from said at least one bar, to engage into said at least one slot of said seat, and to anchor said at least one bar to said seat.

7. The toilet seat device as claimed in claim 1, wherein said seat includes a protuberance extended therefrom, for engaging into the lavatory bowl, and for anchoring said seat to the lavatory bowl.

8. The toilet seat device as claimed in claim 1 further comprising at least one arm rest device attached to said seat.

9. The toilet seat device as claimed in claim 8, wherein said at least one arm rest device includes an arm attached to said seat.

10. The toilet seat device as claimed in claim 9, wherein said seat includes at least one extension extended therefrom, said arm includes a first end pivotally secured to said at least one extension of said seat.

11. The toilet seat device as claimed in claim 10, wherein said at least one extension of said seat includes a projection extended therefrom, and said first end of said arm is pivotally secured to said projection of said at least one extension of said seat with a pivot pin.

12. The toilet seat device as claimed in claim 10, wherein said seat includes a second extension extended therefrom, said arm includes a second end attached to said second extension of said seat.

13. The toilet seat device as claimed in claim 10, wherein said second extension of said seat includes a depression formed therein, and second end of said arm is received in said depression of said second extension of said seat.

14-19. (canceled)
